(19) United States
(12) Patent Application Publication
(10) Pub. No.: US 2016/0202775 A1
(43) Pub. Date: Jul. 14, 2016

(54) RELATIVE LOCATION DETERMINING METHOD, DISPLAY CONTROLLING METHOD AND SYSTEM APPLYING THE METHOD

(71) Applicant: PixArt Imaging Inc., Hsin-Chu City (TW)

(72) Inventors: Shu-Sian Yang, Hsin-Chu City (TW); Han-Ping Cheng, Hsin-Chu City (TW)

(21) Appl. No.: 14/855,385

(22) Filed: Sep. 16, 2015

(30) Foreign Application Priority Data
Jan. 8, 2015 (TW) 104100559

(51) Int. Cl. G06F 3/0346; G06F 3/01; H04N 5/225; G06F 3/038

(52) U.S. Cl. CPC G06F 3/0346; G06F 3/038; G06F 3/017; H04N 5/225

(57) ABSTRACT

A display controlling method, applied to a display, comprising: (a) applying a target apparatus to capture an image to be compared; (b) comparing image content of the image to be compared and image content of a reference image to generate image relation information; (c) determining a relative location between the target apparatus and the display according to the image relation information; and (d) controlling the display to display an image according to the relative location. The steps (a), (b) and (c) can constitute a relative location determining method. The present invention also discloses systems applying the methods.

### BACKGROUND OF THE INVENTION

1. Field of the Invention

The present invention relates to a relative location determining method, a display controlling method and a system applying these methods, and particularly relates to a relative location determining method, a display controlling method applying a display without a fixed reference point and a system applying these methods.

2. Description of the Prior Art

FIG. 1 is a schematic diagram illustrating a prior art direct pointing apparatus. As depicted in FIG. 1, the direct pointing apparatus 100 comprises a remote controller 101 and a host 103. A user can control a cursor Cr on the display 105 via the remote controller 101. In order to correctly determine a relative location between the remote controller 101 and the display 105, the display 105 always comprises a fixed reference point thereon, which is applied to locate the remote controller 101. For example, the fixed reference points can be light sources L1, L2 provided on the display 105.

The remote controller 101 always comprises a control circuit, which is respectively coupled to a camera, a computing unit and a communication interface provided therein. The communication interface is coupled to the host 103, and a lens is provided in front of the camera. If the user applies the direct pointing apparatus 100 to control the program executed by the host 103, the camera can be applied to shoot the display 105. The pictures shot by the camera only comprises light emitted from the light sources L1, L2, since the lens provided in front of the camera can filter light other than the light emitted from the light sources L1, L2. Also, the coordinate value for the aiming point of the camera can be computed by the computing unit, and then transmitted to the host 103. By this way, the host 103 can control the cursor Cr on the display 105 via such coordinate value.

However, if at least one fixed light source is provided on the display 105, the appearance of the display 105 may be affected. Some direct pointing apparatus 100 determines the relative location between the remote controller 101 and the display 105 via fixed objects I1, 12 displayed on the display. However, such fixed objects I1, I2 may block the content displayed on the display 105. Further, if the content displayed on the display 105 is similar with the fixed objects I1, I2, the relative location between the remote controller 101 and the display 105 maybe wrongly determined.

### SUMMARY OF THE INVENTION

Therefore, one objective of the present invention is to provide a relative location determining method, and a system applying such method.

Another objective of the present invention is to provide a display controlling method, and a system applying such method.

One embodiment of the present invention discloses a relative location determining method, applied to determine a relative location between a target apparatus and a display. The method comprises: (a) acquiring an image to be compared via the target apparatus; (b) comparing image content of the image to be compared with image content of a reference image to generate image relation information; and (c) determining the relative location according to the image relation information.

Another embodiment of the present invention discloses a display controlling method, applied to a display. The method comprises: (a) acquiring an image to be compared via a target apparatus; (b) comparing image content of the image to be compared with image content of a reference image to generate image relation information; (c) determining a relative location between the target apparatus and the display according to the image relation information; and (d) controlling the display to display image according to the relative location.

The present invention further discloses a relative location determining system and a display control system, which respectively applies the above-mentioned relative location determining method and the display controlling method. The detail operations of the systems can be acquired based on above-mentioned methods, thus the descriptions thereof are omitted for brevity here.

In view of above-mentioned embodiments, the relative location between the target apparatus and the display can be determined and control the display accordingly, even if the display does not comprise fixed reference points. Further, the detecting range for horizontal movement of the target apparatus can be extended, thus the application of the display control system is extended.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a prior art direct pointing apparatus.

FIG. 2 is a schematic diagram illustrating a display controlling method according to one embodiment of the present invention.

FIG. 3 and FIG. 4 are schematic diagrams illustrating a relation between a reference image and an image to be compared according to different embodiments of the present invention.

FIG. 5 is a schematic diagram illustrating a display controlling method according to another embodiment of the present invention.

FIG. 6 and FIG. 7 are schematic diagrams illustrating reference images according to different embodiments of the present invention.

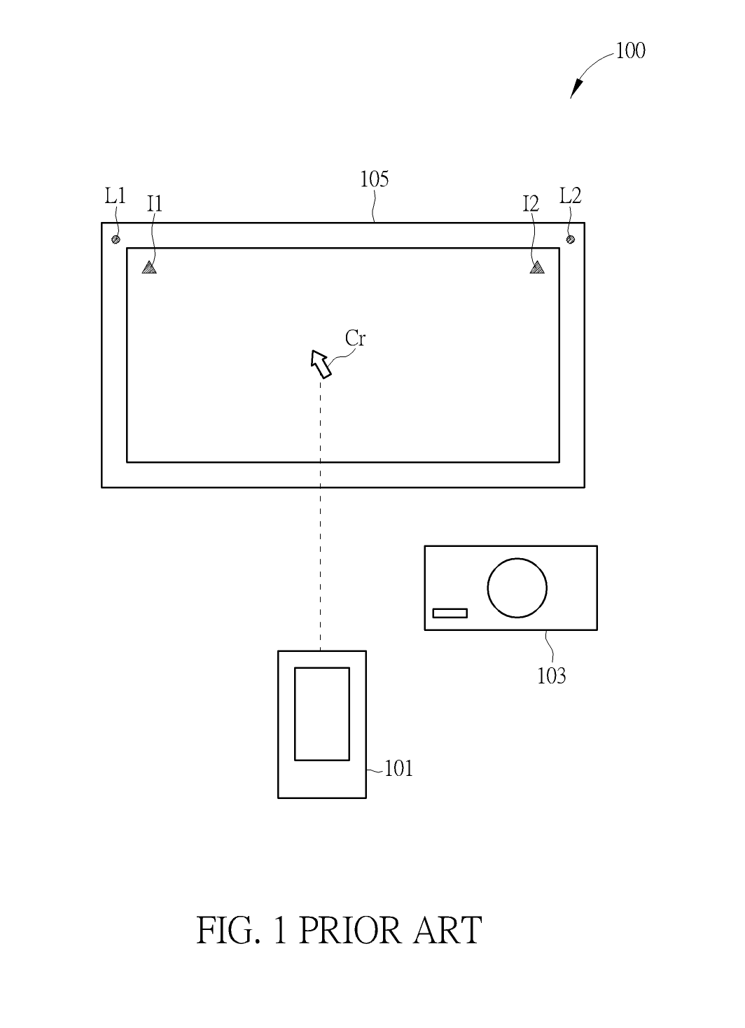

### DETAILED DESCRIPTION

Different embodiments are provided as following to explain the concept of the present invention. Please note, a display control system comprising a remote controller and a host is provided as an example for explaining. Such system can be applied as the above-mentioned direct pointing apparatus, but the concept of the present application is not limited to be applied to such hardware. Any hardware that can apply the concept of the present invention should fall in the scope of the present invention. Besides, for the convenience of description, some conventional devices are not illustrated or depicted. For example, the camera 201 can apply a camera provided therein to capture an image. Such device is not depicted in following description.

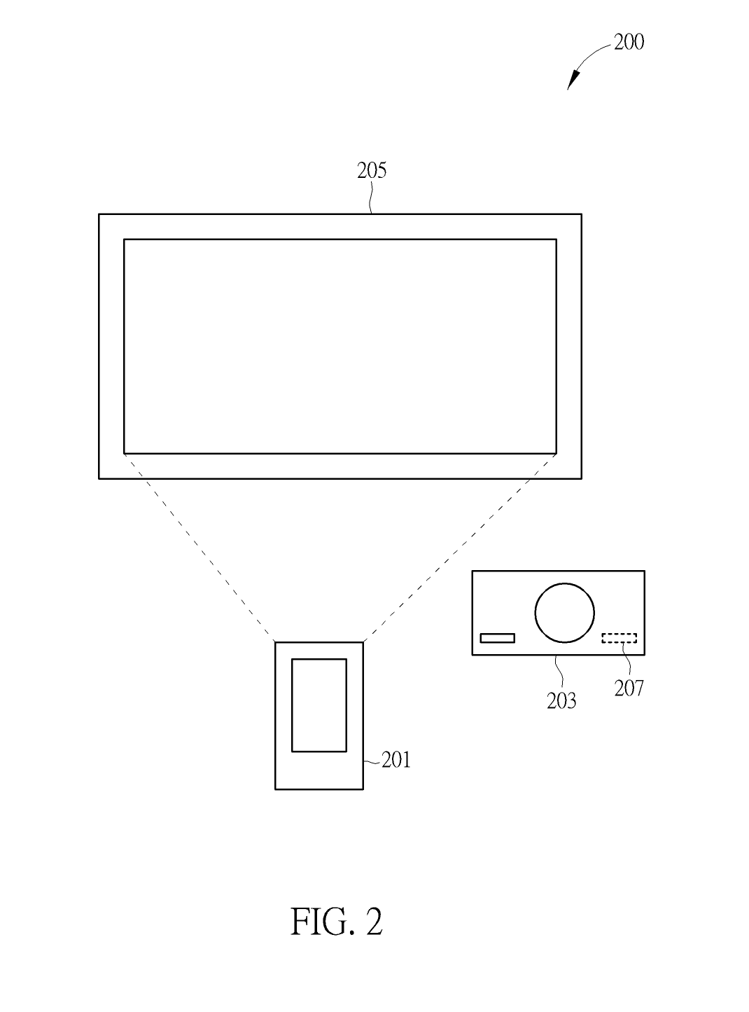

FIG. 2 is a schematic diagram illustrating a display controlling method according to one embodiment of the present invention. As illustrated in FIG. 2, the display control system 200 comprises a remote controller 201 and a host 203. In one embodiment, the host 203 comprises a control unit 207 to perform following operations. However, please note the control unit 207 can be provided in the remote controller 201 as well. In one embodiment of the present invention, the remote controller 201 captures an image to be compared, the control unit 207 compares image content of the image to be compared with image content of a reference image to generate image relation information. The control unit 207 determines the relative location of the remote controller 201 and the display 205 according to the image relation information. After that, the display 205 is controlled to display image according to the relative location, for example, moving a cursor according to the relative location. In one embodiment, the display 205 does not comprise any fixed reference point (ex. the above-mentioned fixed light source or object). In such case, a conventional location determining method cannot be applied to determine a relation between the remote controller 201 and the display 205. The reference image can be an image displayed on the display 205, or the image displayed on the display 205 plus an image in a predetermined range of the display 205, or an image in a predetermined range of the display 205 excluding the image displayed on the display 205. Details of the reference image will be described later.

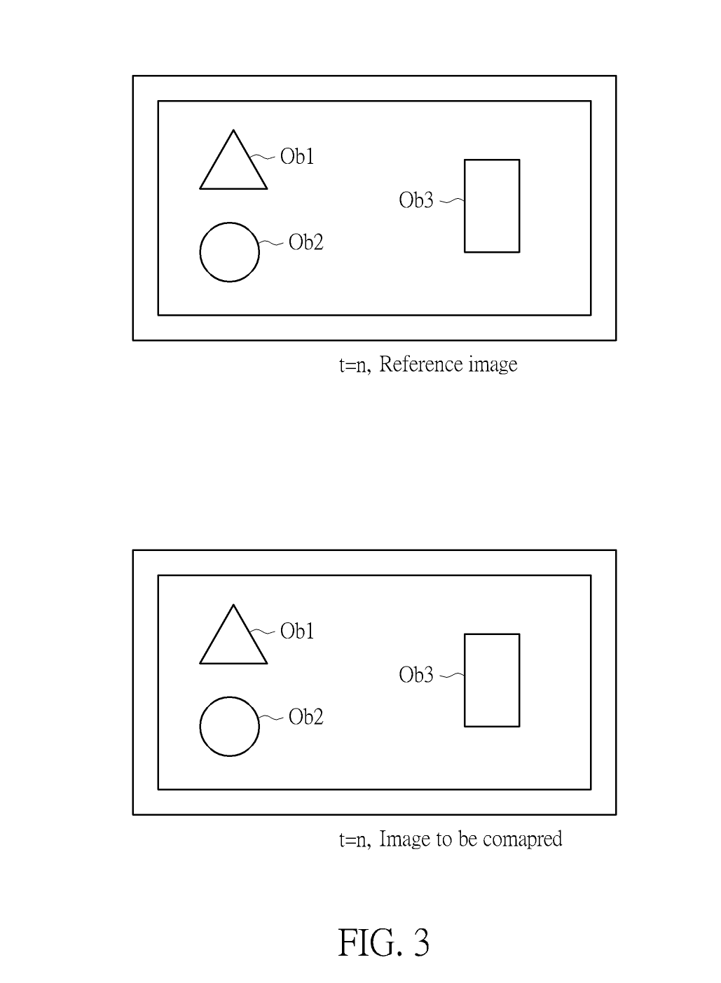

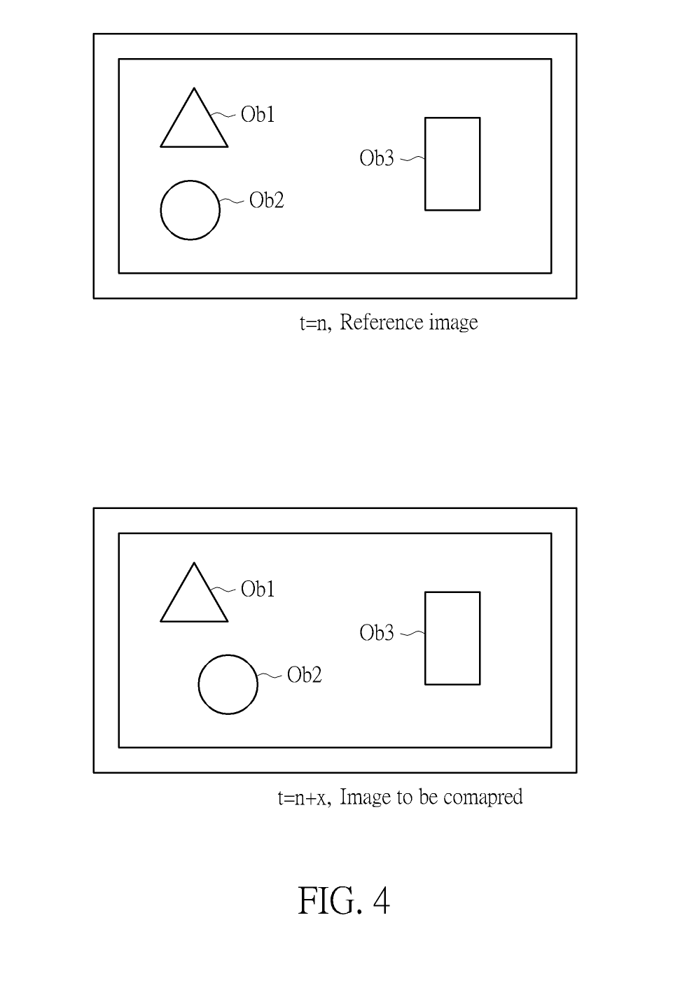

FIG. 3 and FIG. 4 are schematic diagrams illustrating a relation between a reference image and an image to be compared according to different embodiments of the present invention. In the embodiments of FIG. 3 and FIG. 4, the reference image is the image displayed on the display 205. In the embodiment of FIG. 3, the reference image is a real time image displayed on the display 205 (in this example, the image at t=n). In such case, the remote controller 201 captures the image displayed by the display 205 as the image to be compared, at t=n. In such case, a real time image generating apparatus is provided to generate the real time image. The real time image generating apparatus simultaneously provides the real time image to the control unit 207 as the reference image while the real time image generating apparatus generating the real time image to the display 205. As above-mentioned, the control unit 207 is configured to compare image content of the image to be compared with image content of a reference image to generate image relation information, and configured to determine the relative location of the remote controller 201 and the display 205 according to the image relation information. In one embodiment, the real time image generating apparatus is the host 203 in FIG. 2, but the real time image can be generated from other sources. For example, in one embodiment, the real time image is from a television signal, and the control unit is provided in the remote controller 201. In such case, the control unit in the remote controller 201 determines the relative location of the remote controller 201 and the display 205 according to the received television signal and the captured reference image, and controls the image displayed by the display 205 according to the relative location. The embodiment of FIG. 3 can acquire a more accurate location determining result since the latest real time image is applied as a standard for location determination.

Many methods can be applied to generate image relation information. For example, relations between at least one feature of the reference image and at least one feature of the image to be compared can be applied to generate the image relation information. Also, the above-mentioned feature can be an object in the image. Take FIG. 3 for example, the reference image comprises objects Ob1, Ob2 and Ob3, and the image to be compared also comprises objects Ob1, Ob2 and Ob3 as well. Accordingly, the control unit can compare at least one of the objects Ob1, Ob2 and Ob3, and determines the relative location of the remote controller 201 and the display 205 according to parameters for the objects in the reference image and the image to be compared, such as a size, an angle and deformation. The abovementioned feature can be various kinds of images as well, for example, an image with a specific brightness distribution, or an image with a specific shape. For example, a corner of the display always has a right angle, thus an image with a right angle is generated. Such kind of image can be applied as a feature to generate the image relation information. Please note the above-mentioned example for generating the image relation information is only for example, but does not mean to limit the scope of the present invention.

In another embodiment, the control unit 207 receives an external signal from a source outside the remote controller 201 and the display 205 as the reference image, which comprises a part of or all content for the real time image. For example, the display 205 and the control unit 207 simultaneously receive television signals. The display 205 displays complete content for the television programs, and the control unit 207 applies part of or complete content for the television programs as the reference image.

In the embodiment of FIG. 4, the reference image is the image displayed by the display at a specific time point. For example, the reference image is the image displayed by the display 205 at t=n, and the image to be compared is the image captured by the remote controller 201 at t=n+x. x is a positive rational number. That is, the image to be compared is an image after the reference image. Please refer to FIG. 4, the object Ob2 is a little different since the image to be compared is an image after the reference image. However, for such case, the relative location of the remote controller 201 and the display 205 can still be acquired via above-mentioned methods, such as comparing features. Via such method, the transmitting amount for data can be reduced, since the real time image generating apparatus does not need to continuously transmit the real time image to the control unit 207. Additionally, the control unit does not need to continuously update the reference image, thus the amount for data computing can be reduced. Please note the above-mentioned embodiments do not mean to limit that the reference image is fixed after it is determined. In one embodiment, the reference image is updated after a specific period. Such method can reduce the power consumption.

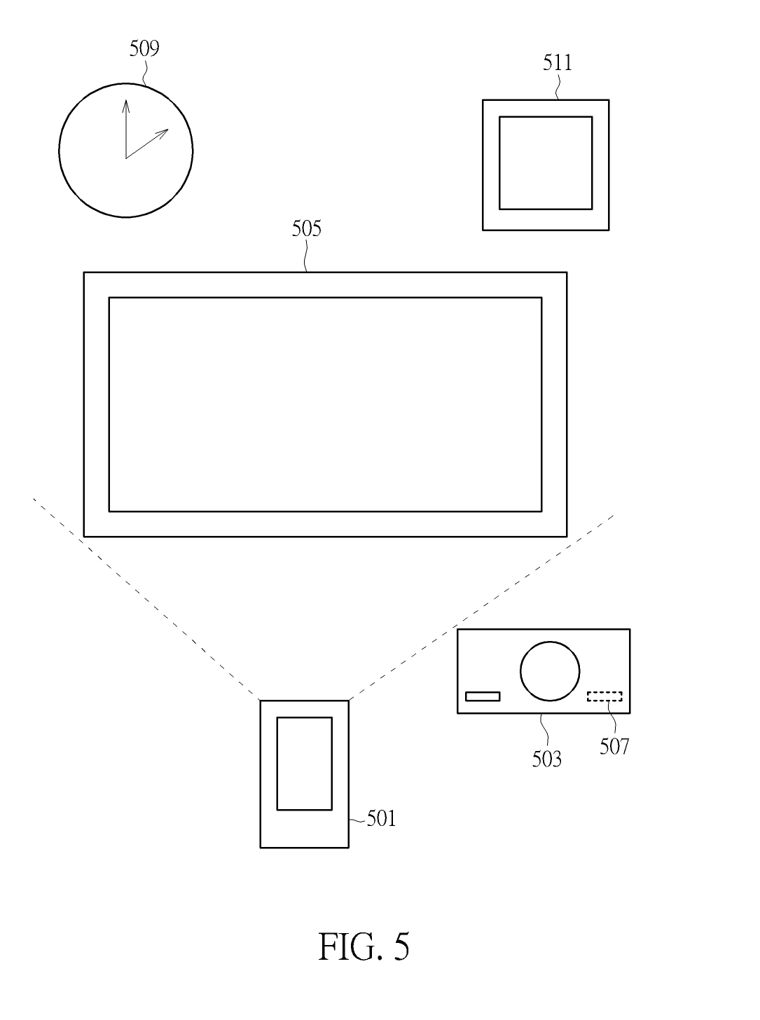

FIG. 5 is a schematic diagram illustrating a display controlling method according to another embodiment of the present invention. In this embodiment, the remote controller 501 further captures the image in a predetermined range of the display 505 besides the image displayed on the display 505. Take FIG. 5 for example, the remote controller 501 also captures images of the clock 509 and the drawing 511 near the display 505 besides the image displayed on the display 505. In such case, the reference image can comprise the image displayed on the display 505, images of the clock 509 and the drawing 511, and can comprise only images of the clock 509 and the drawing 511. Related description will be described later. Please note, the clock 509 and the drawing 511 are only examples for explaining, any image in a predetermined range of the display 505 should also fall in the scope of the present invention.

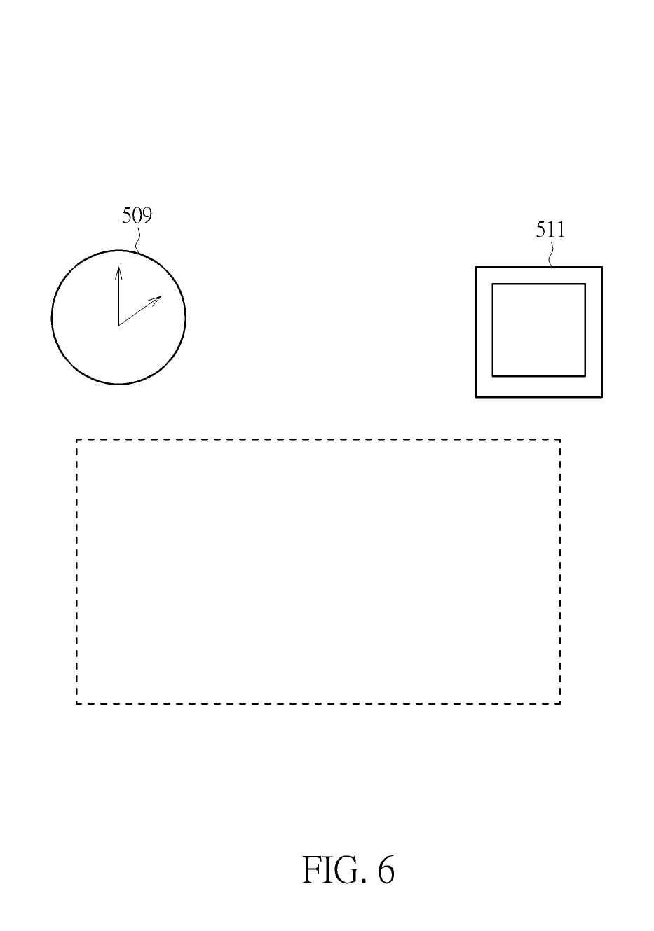

In the embodiment of FIG. 6, the reference image comprises images of the clock 509 and the drawing 511, but the content displayed on the display 505 is excluded. In one embodiment, the border of the display 505 is classified to the image displayed on the display 505. In such embodiment, the border of the display 505 and the image displayed on the display 505 are both excluded from the reference image. Accordingly, even the image to be compared captured by the remote controller 501 comprises the image displayed on the display 505, images of the clock 509 and the drawing 511, the control unit 507 determines the relative location between the remote controller 501 and the display 505 only according to images of the clock 509 and the drawing 511 (or plus the boarder of the display 505) rather than all of the image displayed on the display 505, images of the clock 509 and the drawing 511 since the image displayed on the display 505 is excluded from the reference image.

Many methods can be applied to confirm the location of the display 505 and exclude the content displayed on the display 505. In one embodiment, the display 505 displays a specific image (ex. a specific symbol), and then the control unit determines a display range of the display 505, and controls the reference image to exclude the image displayed on the display according to the display range.

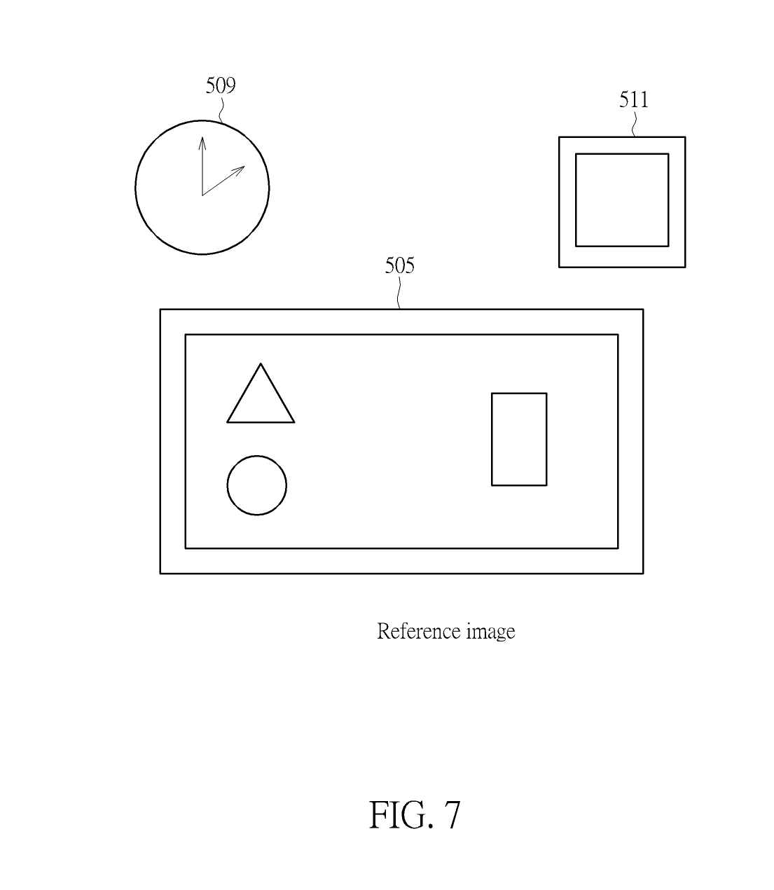

In the embodiment of FIG. 7, the reference image comprises images of the clock 509, the drawing 511, and comprises the image displayed on the display 505. The image displayed on the display 505 can be a real time image as stated in FIG. 3, or an image at a specific time point, as stated in FIG. 4. The control unit 507 determines the relative location between the remote controller 501 and the display 505 according to the image displayed on the display 505, images of the clock 509 and the drawing 511.

The above-mentioned display controlling methods can be applied to various operations. For example, the method can be applied to control the cursor on the display to select a program to be executed. Alternatively, the method can be applied to control the action for a role in a game while the host executing a game program. These control methods can be regarded as controlling the display to display different images. In one embodiment, the control unit determines a horizontal move distance or a horizontal move speed of the target apparatus according to a plurality of the relative locations between the remote controller and the display, and controls the display to display the image according to the horizontal move distance or the horizontal move speed. In prior art, since the fixed reference point is applied to determine the relative location, the horizontal move distance or the horizontal move speed that can be determined are limited to a narrow range. Accordingly, via such mechanism, the detecting range for the horizontal movement of the remote controller can be extended. Also, via such mechanism, the remote controller can detect the horizontal move distance or the horizontal move speed without a gyro sensor. Also, a gesture control operation can be performed based on a plurality of the relative locations between the remote controller and the display. For example, if the user holds the remote controller and draws a circle in the air, the gesture for drawing a circle can be detected based on a plurality of the relative locations. The host will perform a predetermined operation based on such gesture.

The above-mentioned remote controller can be a particular remote controller for the host, or a portable electronic apparatus (ex. a mobile phone). Therefore, the above-mentioned remote controller can be regarded a target apparatus, and the location of such target apparatus is waited to be determined. Accordingly, a display control system provided by the present invention can be summarized as: a display control system comprising: a target apparatus (ex. 201), configured to acquire an image to be compared; and a control unit (ex. 207), configured to compare image content of the image to be compared with image content of a reference image to generate image relation information, and configured to determine the relative location between the target apparatus and a display (ex. 205) according to the image relation information. The control unit further controls the display to display image according to the relative location. As above-mentioned, the control unit can be provided in the target apparatus or the host.

Such system can be applied to only determine the relative location between the target apparatus and the display rather than control the display to display image according to the relative location. Therefore, based upon above-mentioned embodiments, the present invention also provides a relative location determining system, which comprises: a target apparatus (ex. 201), configured to acquire an image to be compared; and a control unit (ex. 207), configured to compare image content of the image to be compared with image content of a reference image to generate image relation information, and configured to determine the relative location according to the image relation information.

Detail operations for above-mentioned systems can be acquired in view of above-mentioned description, thus are omitted for brevity here.

In view of above-mentioned embodiments, a relative location determining method can be acquired, which is applied to determine a relative location between a target apparatus (ex. 201) and a display (ex. 205). The method comprises: (a) acquiring an image to be compared via the target apparatus; (b) comparing image content of the image to be compared with image content of a reference image to generate image relation information; and (c) determining the relative location according to the image relation information. Further, a display controlling method can be acquired, which is applied to a display. The method comprises: (a) acquiring an image to be compared via a target apparatus (ex. 201) ; (b) comparing image content of the image to be compared with image content of a reference image to generate image relation information; (c) determining the relative location according to the image relation information; and (d) controlling the display to display image according to the relative location.

In view of above-mentioned embodiments, the relative location between the target apparatus and the display can be determined and control the display accordingly, even if the display does not comprise fixed reference points. Further, the detecting range for horizontal movement of the target apparatus can be extended, thus the application of the display control system is extended.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A relative location determining method, applied to determine a relative location between a target apparatus and a display, comprising:
(a) acquiring an image to be compared via the target apparatus;
(b) comparing image content of the image to be compared with image content of a reference image to generate image relation information; and
(c) determining the relative location according to the image relation information.

2. The relative location determining method of claim 1, wherein the step (b) is performed by a control unit, wherein the control unit is located in the target apparatus or a host configured to control the target apparatus, wherein the control unit generates the reference image according to an external signal from a source outside the target apparatus and the host, wherein the reference image comprises at least part content of a real time image displayed on the display.

3. The relative location determining method of claim 1, wherein the display does not comprise a fixed reference point for locating the target apparatus.

4. The relative location determining method of claim 1, wherein the step (b) comprises: generating the image relation information according to a relation between at least one feature in the image to be compared and at least one feature in the reference image.

5. The relative location determining method of claim 1, wherein the reference image is a real time image displayed on the display.

6. The relative location determining method of claim 5, wherein the step (b) is performed by a control unit, and the real time image is generated by a real time image generating apparatus, wherein the real time image generating apparatus simultaneously provides the real time image to the control unit while the real time image generating apparatus generating the real time image to the display.

7. The relative location determining method of claim 1, wherein the reference image comprises an image which is displayed by the display at a specific time point and an image in a predetermined range of the display.

8. The relative location determining method of claim 1, wherein the reference image comprises a real time image displayed by the display and an image in a predetermined range of the display.

9. The relative location determining method of claim 8, wherein the step (b) is performed by a control unit, and the real time image is generated by a real time image generating apparatus, wherein the real time image generating apparatus simultaneously provides the real time image to the control unit while the real time image generating apparatus generating the real time image to the display.

10. The relative location determining method of claim 1, wherein the reference image comprises an image in a predetermined range of the display and excludes the image displayed on the display.

11. The relative location determining method of claim 10, further comprising:
controlling the display to display a specific image;
determining a display range of the display based on the specific image; and
controlling the reference image to exclude the image displayed on the display according to the display range.

12. A display controlling method, applied to a display, comprising:
(a) acquiring an image to be compared via a target apparatus;
(b) comparing image content of the image to be compared with image content of a reference image to generate image relation information;
(c) determining a relative location between the target apparatus and the display according to the image relation information; and
(d) controlling the display to display image according to the relative location.

13. The display controlling method of claim 12, wherein the step (b) is performed by a control unit, wherein the control unit is located in the target apparatus or a host configured to control the target apparatus, wherein the control unit generates the reference image according to an external signal from a source outside the target apparatus and the host, wherein the reference image comprises at least part content of a real time image displayed on the display.

14. The display controlling method of claim 12, wherein the display does not comprise a fixed reference point for locating the target apparatus.

15. The display controlling method of claim 12, wherein the step (b) comprises: generating the image relation information according to a relation between at least one feature in the image to be compared and at least one feature in the reference image.

16. The display controlling method of claim 12, wherein the reference image is a real time image displayed on the display.

17. The display controlling method of claim 16, wherein the step (b) is performed by a control unit, and the real time image is generated by a real time image generating apparatus, wherein the real time image generating apparatus simultaneously provides the real time image to the control unit while the real time image generating apparatus generating the real time image to the display.

18. The display controlling method of claim 12, wherein the reference image comprises an image which is displayed by the display at a specific time point and an image in a predetermined range of the display.

19. The display controlling method of claim 12, wherein the reference image comprises a real time image displayed by the display and an image in a predetermined range of the display.

20. The display controlling method of claim 19, wherein the step (b) is performed by a control unit, and the real time image is generated by a real time image generating apparatus, wherein the real time image generating apparatus simultaneously provides the real time image to the control unit while the real time image generating apparatus generating the real time image to the display.

21. The display controlling method of claim 12, wherein the reference image comprises an image in a predetermined range of the display and excludes the image displayed on the display.

22. The display controlling method of claim 21, further comprising:
controlling the display to display a specific image;
determining a display range of the display based on the specific image; and
controlling the reference image to exclude the image displayed on the display according to the display range.

23. The display controlling method of claim 12, further comprising:
determining a horizontal move distance or a horizontal move speed of the target apparatus according to a plurality of the relative locations; and
controlling the display to display the image according to the horizontal move distance or the horizontal move speed.

24. A relative location determining system, comprising:
a target apparatus, configured to acquire an image to be compared; and
a control unit, configured to compare image content of the image to be compared with image content of a reference image to generate image relation information, and configured to determine the relative location according to the image relation information.

25. The relative location determining system of claim 24, further comprising a host configured to control the target apparatus, wherein the control unit generates the reference image according to an external signal from a source outside the target apparatus and the host, wherein the reference image comprises at least part content of a real time image displayed on the display.

26. The relative location determining system of claim 24, wherein the display does not comprise a fixed reference point for locating the target apparatus.

27. The relative location determining system of claim 24, wherein the control unit generates the image relation information according to a relation between at least one feature in the image to be compared and at least one feature in the reference image.

28. The relative location determining system of claim 24, wherein the reference image is a real time image displayed on the display.

29. The relative location determining system of claim 28, further comprising:
a real time image generating apparatus, configured to generate the real time image, wherein the real time image generating apparatus simultaneously provides the real time image to the control unit while the real time image generating apparatus generating the real time image to the display.

30. The relative location determining system of claim 24, wherein the reference image comprises an image which is displayed by the display at a specific time point and an image in a predetermined range of the display.

31. The relative location determining system of claim 24, wherein the reference image comprises a real time image displayed by the display and an image in a predetermined range of the display.

32. The relative location determining system of claim 31, further comprising:
a real time image generating apparatus, configured to generate the real time image,
wherein the real time image generating apparatus simultaneously provides the real time image to the control unit while the real time image generating apparatus generating the real time image to the display.

33. The relative location determining system of claim 24, wherein the reference image comprises an image in a predetermined range of the display and excludes the image displayed on the display.

34. The relative location determining system of claim 33, wherein the control unit determines a display range of the display based on a specific image displayed on the display, and controls the reference image to exclude the image displayed on the display according to the display range.

35. A display control system, comprising:
a target apparatus, configured to acquire an image to be compared; and
a control unit, configured to compare image content of the image to be compared with image content of a reference image to generate image relation information, and configured to determine the relative location between the target apparatus and a display according to the image relation information;
wherein the control unit further controls the display to display image according to the relative location.

36. The display control system of claim 35, further comprising a host configured to control the target apparatus, wherein the control unit generates the reference image according to an external signal from a source outside the target apparatus and the host, wherein the reference image comprises at least part content of a real time image displayed on the display.

37. The display control system of claim 35, wherein the display does not comprise a fixed reference point for locating the target apparatus.

38. The display control system of claim 35, wherein the control unit generates the image relation information according to a relation between at least one feature in the image to be compared and at least one feature in the reference image.

39. The display control system of claim 35, wherein the reference image is a real time image displayed on the display.

40. The display control system of claim 39, further comprising:
a real time image generating apparatus, configured to generate the real time image, wherein the real time image generating apparatus simultaneously provides the real time image to the control unit while the real time image generating apparatus generating the real time image to the display.

41. The display control system of claim 35, wherein the reference image comprises an image which is displayed by the display at a specific time point and an image in a predetermined range of the display.

42. The display control system of claim 35, wherein the reference image comprises a real time image displayed by the display and an image in a predetermined range of the display.

43. The display control system of claim 42, further comprising:
a real time image generating apparatus, configured to generate the real time image,
wherein the real time image generating apparatus simultaneously provides the real time image to the control unit while the real time image generating apparatus generating the real time image to the display.

44. The display control system of claim 35, wherein the reference image comprises an image in a predetermined range of the display and excludes the image displayed on the display.

45. The display control system of claim 44, wherein the control unit determines a display range of the display based on a specific image displayed on the display, and controls the reference image to exclude the image displayed on the display according to the display range.

46. The display control system of claim 35, wherein the control unit determines a horizontal move distance or a horizontal move speed of the target apparatus according to a plurality of the relative locations, and controls the display to display the image according to the horizontal move distance or the horizontal move speed.
